(19) United States
(12) Patent Application Publication
(10) Pub. No.: US 2016/0034553 A1
(43) Pub. Date: Feb. 4, 2016

(54) HYBRID AGGREGATION OF DATA SETS

(71) Applicant: Linkedln Corporation, Mountain View, CA (US)

(72) Inventors: Kuisong Tong, San Jose, CA (US); Jiye Wu, San Jose, CA (US)

(21) Appl. No.: 14/447,172

(22) Filed: Jul. 30, 2014

(51) Int. Cl. G06F 17/30

(52) U.S. Cl. CPC G06F 17/30598; G06F 17/30554

(57) ABSTRACT

The disclosed embodiments provide a system for processing data. During operation, the system obtains one or more filters associated with dimensions of a data set. Next, the system calculates a cardinality associated with the one or more filters. The system then adjusts a level of aggregation of a query associated with the one or more filters based on the cardinality and a query result limit for querying of the data set. Finally, the system uses the query to obtain a set of records from the data set.

### BACKGROUND

1. Field

The disclosed embodiments relate to data analysis. More specifically, the disclosed embodiments relate to techniques for performing hybrid aggregation of data sets.

2. Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers. In addition, querying of large data sets may result in high server latency and/or server timeouts (e.g., during processing of requests for aggregated data) and/or the crashing of client-side applications such as web browsers (e.g., due to high data volume).

Consequently, big data analytics may be facilitated by mechanisms for efficiently and/or effectively collecting, storing, managing, querying, analyzing, and/or visualizing large data sets.

### BRIEF DESCRIPTION OF THE FIGURES

FIG. 1 shows a schematic of a system in accordance with the disclosed embodiments.

FIG. 2 shows the generation of a set of queries for a data set in accordance with the disclosed embodiments.

FIG. 3 shows an exemplary screenshot in accordance with the disclosed embodiments.

FIG. 4 shows a flowchart illustrating the process of processing data in accordance with the disclosed embodiments.

FIG. 5 shows a flowchart illustrating the process of processing an update to one or more filters associated with dimensions of a data set in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

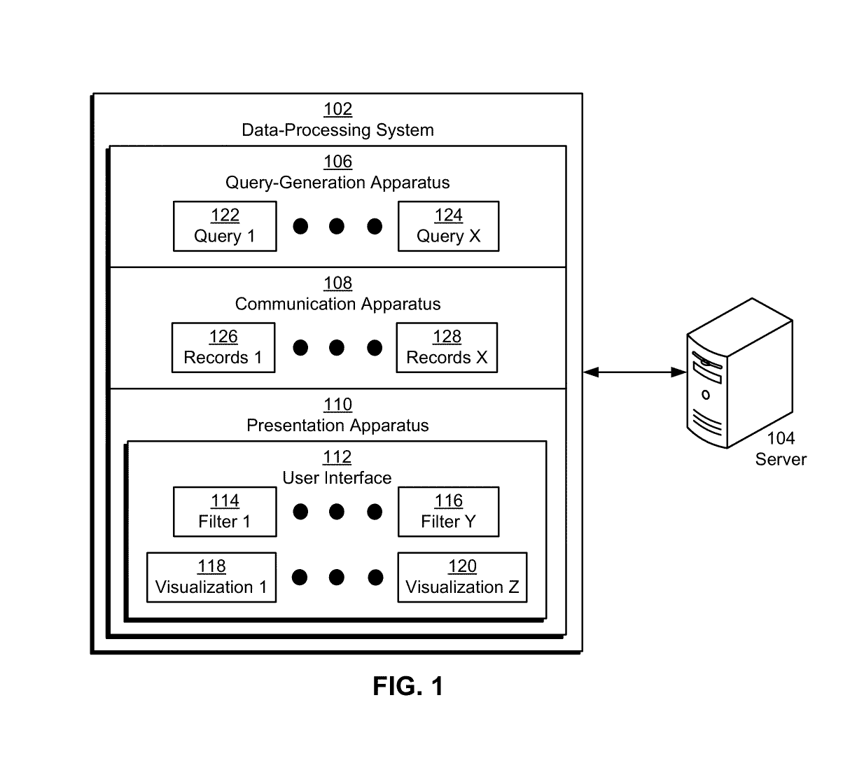

The disclosed embodiments provide a method and system for processing data. As shown in FIG. 1, the system may be a data-processing system 102 that uses a network connection to retrieve data from a server 104 and provide one or more visualizations (e.g., visualization 1 118, visualization z 120) of the data. For example, a presentation apparatus 110 in data-processing system 102 may provide a user interface 112 (e.g., a graphical user interface (GUI)) that displays line charts, bar charts, histograms, pie charts, and/or other graphical representations of a data set provided by a database, data warehouse, filesystem, table, cache, and/or other storage mechanism provided by and/or accessible to server 104. Presentation apparatus 110 may also include raw data, summary statistics, and/or other information related to the data set in user interface 112.

Presentation apparatus 110 may also enable interaction with and/or configuration of the visualizations and/or information displayed within user interface 112. More specifically, presentation apparatus 110 may allow a user to specify one or more filters (e.g., filter 1 114, filter y 116) associated with dimensions of the data set. Each filter may specify a value, range of values, and/or flag for a dimension. In turn, visualizations and/or information shown in user interface 112 may be based on data from the data set that matches the specified filters. For example, presentation apparatus 110 may show visualizations and/or information related to data that matches a specified date range, location, event, category, identifier, and/or status obtained through user interface 112. Presentation apparatus 110 may thus facilitate the discovery of relationships, patterns, and/or trends in the data; gaining of insights from the data; and/or the guidance of decisions and/or actions related to the data.

To enable the display of visualizations and/or other information related to the data in user interface 112, a query-generation apparatus 106 in data-processing system 102 may generate a set of queries (e.g., query 1 122, query x 124) that are used to retrieve the data from server 104. For example, query-generation apparatus 106 may create queries that specify one or more metrics and/or dimensions associated with the data set. Each metric may represent a measureable and/or quantitative value in the data set, while each dimension may categorize, group, and/or label values of the metrics in the data set.

A communication apparatus 108 in data-processing system 102 may transmit the queries over one or more networks to server 104, and server 104 may process each query by retrieving a set of records (e.g., records 1 126, records x 128) matching the query from the data set. Server 104 may transmit the records over the network(s) to communication apparatus 108, and presentation apparatus 110 may use the records to generate the visualizations and/or obtain (e.g., calculate) other information that is displayed within the user interface.

Consequently, data-processing system 102 and server 104 may implement a client-server architecture that supports analytics of large data sets. For example, data-processing system 102 may be provided by a web application executing in a web browser, which accesses a data set on a remote server 104 using a wired and/or wireless network connection with server 104. Alternatively, data-processing system 102 may be provided by a native application, mobile application, and/or distributed application that executes on one or more network-enabled electronic devices, such as personal computers, laptop computers, mobile phones, tablet computers, portable media players, and/or workstations.

During processing of queries of large data sets, server 104 may aggregate data matching the queries and return the aggregated data in response to the queries. For example, server 104 may combine multiple records with the same values for one or more dimensions into sums, counts, maximums, minimums, and/or summary statistics of metrics associated with the dimension(s) from the records. Server 104 may then provide the combined records to communication apparatus 108 in lieu of non-aggregated records to reduce the amount of data transmitted between server 104 and data-processing system 102.

Those skilled in the art will appreciate that querying of large data sets may result in overloading of data-processing system 102 and/or server 104. For example, a large query for aggregated data from data-processing system 102 may result in a timeout on server 104 because server 104 is unable to process the query in a reasonable amount of time. On the other hand, a query for a large set of non-aggregated data may return too many records for data-processing system 102 to efficiently process and/or receive. In other words, querying of large data sets on server 104 by data-processing system 102 may increase the response and/or processing times associated with the data sets and potentially cause data-processing system 102 and/or server 104 to crash.

In one or more embodiments, data-processing system 102 includes functionality to structure queries in a way that averts overloading and/or timeouts on server 104 and/or data-processing system 102. As described in further detail below, query-generation apparatus 106 may adjust a level of aggregation and/or partitioning of queries to server 104 based on the filters from presentation apparatus 110 and/or a cardinality associated with the filters. The cardinality may represent the expected number of records associated with the filters. As a result, a higher cardinality may represent higher volume and, in turn, more processing by data-processing system 102. On the other hand, a lower cardinality may represent lower volume, indicating more aggregation by server 104. The level of aggregation may thus be adjusted to prevent overloading of data-processing system 102 or server 104, and the level of partitioning may be adjusted to prevent timeouts on server 104.

Those skilled in the art will appreciate that the system of FIG. 1 may be implemented in a variety of ways. As mentioned above, data-processing system 102 may be implemented using a web application, native application, mobile application, and/or distributed application. Data-processing system 102 may also run on various electronic devices with different hardware components and/or resources. As a result, data-processing system 102 may vary the level of aggregation and/or partitioning of queries based on the requirements and/or limitations of both server 104 and the electronic device on which data-processing system 102 executes.

Moreover, query-generation apparatus 106, communication apparatus 108, and presentation apparatus 110 may be implemented together and/or separately by one or more hardware and/or software components and/or layers. For example, query-generation apparatus 106, communication apparatus 108, and presentation apparatus 110 may be provided by one or more software components that execute on one or more electronic devices and utilize hardware resources such as processors, memory, network interfaces, and/or input/output (I/O) devices on the electronic device(s).

Finally, data-processing system 102 may obtain data from server 104 and/or adjust the level of aggregation of the data for a number of purposes. For example, data-processing system 102 may vary the aggregation of data from server 104 during compression of the data, training of a statistical model using the data, and/or generation of reports from the data.

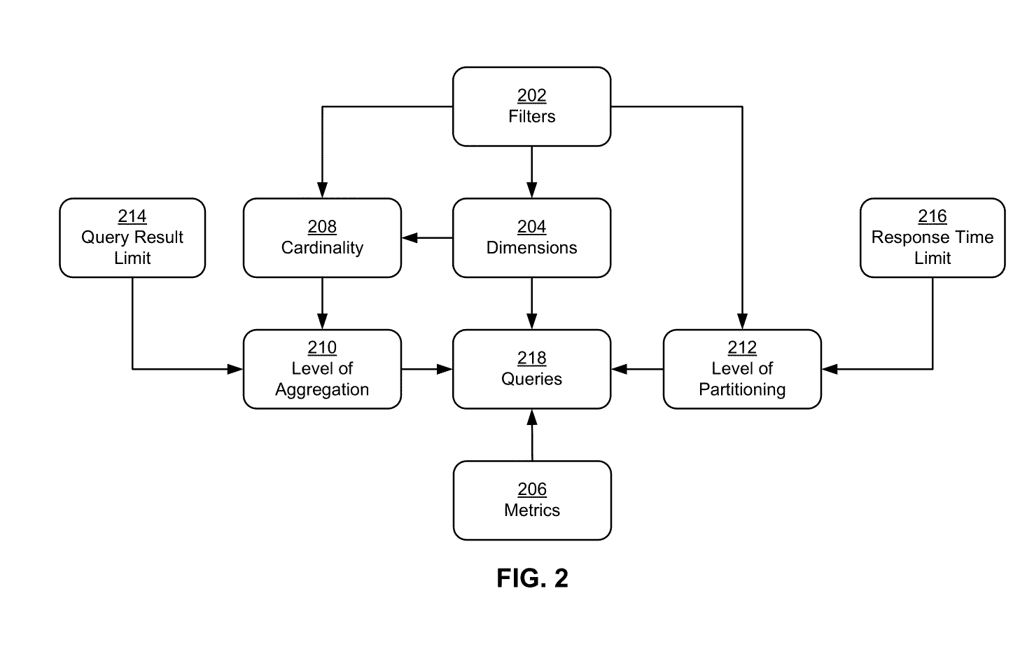

FIG. 2 shows the generation of a set of queries 218 for a data set in accordance with the disclosed embodiments. As described above, queries 218 may be based on one or more filters 202 associated with dimensions 204 of the data set. Dimensions 204 may include categories, groups, flags, and/or labels for metrics 206 in the data set. As a result, each dimension may include a limited set of possible values. For example, dimensions 204 may specify a person's location (e.g., city, state, country), industry, level of education, level of experience, gender, age range, nationality, and/or marital status.

Metrics 206 may represent numeric measurements and/or quantities in the data set. For example, metrics 206 may include revenue, spending, click-through rates, conversions, duration of use, and/or other measurements of business performance. Each metric may be associated with dimensions 204 that categorize, characterize, group, and/or label values for the metric. As a result, records in the data set may include one or more metrics and one or more dimensions associated with the metric(s). For example, a record containing a value of a metric for a click-through rate may also include values associated with a user, web page, advertisement, advertising campaign, location, time, and/or product associated with the click-through rate.

Queries 218 may thus include one or more metrics 206 and one or more dimensions 204 associated with the metric(s). Continuing with the above example, a query may request the click-through rates associated with advertisements from an advertising campaign over a pre-specified period (e.g., the last week).

In one or more embodiments, metrics 206 and dimensions 204 are associated with user activity at an online professional network. The online professional network may allow users to establish and maintain professional connections, list work and community experience, endorse and/or recommend one another, and/or search and apply for jobs. Employers may list jobs, search for potential candidates, and/or provide business-related updates to users. As a result, metrics 206 may track values such as dollar amounts spent, impressions of ads or job postings, clicks on ads or job postings, profile views, messages, and/or job or ad conversions within the online professional network. In turn, dimensions 204 may describe attributes of the users and/or events from which metrics 206 are obtained. For example, dimensions 204 may include the users' industries, titles, seniority levels, employers, skills, and/or locations. Dimensions 204 may also include identifiers for the advertisements, jobs, profiles, and/or employers associated with content viewed and/or transmitted in the events. Metrics 206 and dimensions 204 may thus facilitate understanding and use of the online professional network by advertisers, employers, and/or other customers of the online professional network.

Filters 202 may provide specific values of dimensions 204 to be included in queries 218. For example, filters 202 may specify values (e.g., alphanumeric values), ranges of values (e.g., date ranges, alphabetic ranges, identifier (ID) ranges, etc.), and/or values of flags (e.g., true or false) in dimensions 204 of records in the data set.

In turn, filters 202 and dimensions 204 may be used to calculate a cardinality 208 associated with filters 202. Cardinality 208 may represent an estimate of the number of records of aggregated data to be returned in response to one or more queries 218 containing filters 202 and/or dimensions 204. To calculate cardinality 208, the number of distinct values for each dimension associated with filters 202 may be obtained and multiplied with other numbers of distinct values associated with dimensions 204. For example, filters 202 may be associated with three dimensions that have three, five, and two distinct values, respectively. Cardinality 208 may thus be calculated from the distinct values as 3*5*2, or 30.

Next, a level of aggregation 210 of queries 218 may be adjusted based on cardinality 208 and a query result limit 214 associated with querying of the data set. In particular, level of aggregation 210 may be set so that the estimated number of records returned in response to queries 218 (e.g., cardinality 208) does not exceed query result limit 214. Query result limit 214 may be based on the amount of processor and/or memory resources available on a data-processing system (e.g., data-processing system 102 of FIG. 1) that queries the data set. For example, query result limit 214 may be set to a higher number (e.g., 10,000) if the data-processing system runs on a computer system with robust memory and/or processor resources and a lower number (e.g., 1,000) if the data-processing system executes on a mobile device with limited memory and/or processor resources. As a result, query result limit 214 may reduce processing time on the data-processing system and prevent crashes caused by overloading of the data-processing system.

Level of aggregation 210 may be fully aggregated, semi-aggregated (e.g., half-aggregated), or non-aggregated. A query for fully aggregated data may include all filters 202 to reduce the estimated number of aggregated records returned in response to the query as much as possible. Changes or updates to filters 202 may require the creation of a new query to retrieve data not included in response to the query. A query for semi-aggregated data may omit one or more filters 202 to increase the estimated number of aggregated records in response to the query, up to query result limit 214. For example, a filter for a Boolean dimension may be omitted in the query to increase the number of aggregated records returned in response to the query by up to a factor of two. A query for non-aggregated data may be used to obtain records without any aggregation. For example, one or more queries may be constructed to request the 10,000 most recent records that match one or more filters 202.

Queries 218 may additionally be structured based on a level of partitioning 212, which is adjusted based on filters 202 and a response time limit 216 for querying of the data set. Response time limit 216 may represent a timeout, workload, and/or other threshold representing overloading of a server (e.g., server 104 of FIG. 1) during processing of queries 218. Response time limit 216 may be provided by the server and/or estimated by the data-processing system. To keep processing of a query from exceeding response time limit 216, level of partitioning 212 may be increased to distribute processing associated with the query by the server across multiple queries. For example, an aggregation such as “count distinct” may require significantly more processing by the server than an aggregation such as “sum.” As a result, a query for a “count distinct” aggregation may be partitioned into multiple queries for different portions of aggregated data from a set of records so that each of the queries includes an aggregation of a subset of the records that can be processed by the server within response time limit 216.

Consequently, level of aggregation 210 and level of partitioning 212 may improve querying of the data set by balancing the aggregation of data by the server with subsequent processing and/or querying of the data by the data-processing system. In turn, the construction of queries 218 based on level of aggregation 210 and level of partitioning 212 may reduce response and/or processing times at both the server and data-processing system and prevent overloading of the server and data-processing system.

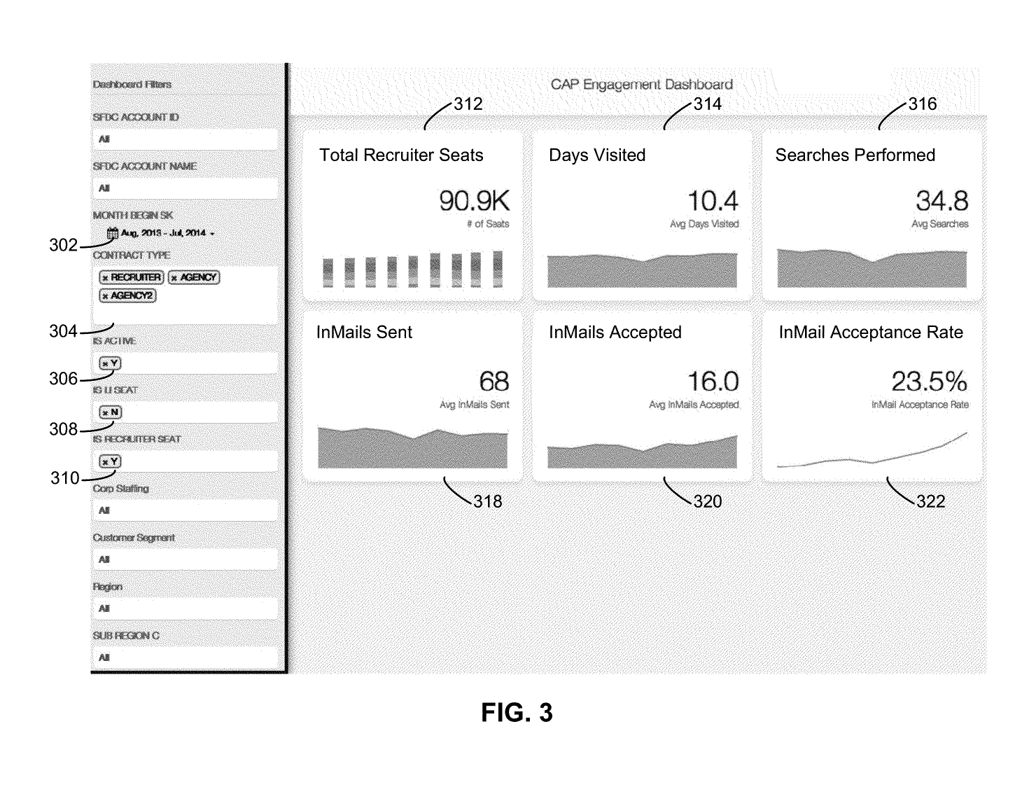

FIG. 3 shows an exemplary screenshot in accordance with the disclosed embodiments. More specifically, FIG. 3 shows a screenshot of a user interface for processing data from a data set, such as user interface 112 of FIG. 1. The user interface includes a set of visualizations 312-322 of the data. For example, visualization 212 may include a color-coded bar chart of a “Total Recruiter Seats” metric, visualization 314 may include a line chart of a “Days Visited” metric, and visualization 316 may include a line chart of a “Searches Performed” metric. Visualization 318 may include a line chart of an “InMails Sent” metric, visualization 320 may include a line chart of an “InMails Accepted” metric, and visualization 322 may include a line chart of an “InMail Acceptance Rate” metric.

The user interface may also include information related to the metrics represented by visualizations 312-322. For example, visualization 312 may include a total number (e.g., a sum) associated with the “Total Recruiter Seats” metric, visualization 314 may include an average associated with the “Days Visited” metric, and visualization 316 may provide an average associated with the “Searches Performed” metric. Visualization 318 may show an average associated with the “InMails Sent” metric, visualization 320 may show an average associated with the “InMails Accepted” Metric, and visualization 322 may show a value associated with the “InMail Acceptance Rate” metric.

The user interface additionally includes a set of user-interface elements for obtaining a set of filters 302-310 associated with dimensions of the data represented by visualizations 312-322. Filter 302 may specify a date range (e.g., “August 2013-July 2014”) for the data, and filter 304 may provide three values (e.g., “RECRUITER,” “AGENCY,” “AGENCY2”) of a “CONTRACT TYPE” dimension in the data. Filters 306-310 may specify Boolean values of true, false, and true for the “IS ACTIVE,” “IS LI SEAT,” and “IS RECRUITER SEAT” dimensions, respectively.

As described above, data represented by visualizations 312-322 may be queried based on a cardinality associated with filters 302-310 and the associated dimensions and a query result limit. The cardinality may be calculated by multiplying the numbers of possible values of the dimensions represented by filters 302. For example, filters 302-310 may have 12, 9, 2, 2, and 2 distinct values, respectively. The cardinality associated with filters 302-310 may thus be calculated as 12*9*2*2*2, or 864. If the query result limit for querying the data set is 10,000, one or more queries may be used to retrieve semi-aggregated data that is grouped by the dimensions associated with filters 302-310.

To obtain semi-aggregated data represented by visualizations 312-322, the queries may request metrics associated with visualizations 312-322 grouped by the dimensions associated with filters 302-310 without specifying values for the dimensions. The filters may then be applied to the data to generate visualizations 312-322 after the data is received in response to the queries from a server (e.g., server 104 of FIG. 1). For example, the data may be filtered by a client-side web browser and/or web application providing the user interface before the data is used to generate visualizations 312-322. In addition, changes to the values of filters 302-310 may be reflected in visualizations 312-322 without additional querying of the server. For example, the removal of filter 306 may result in the inclusion of data that contains either a “true” or a “false” value for the “IS ACTIVE” dimension in visualizations 312-322. Because data that contains both “true” and “false” values for the dimension was previously received in response to the query for semi-aggregated data, visualizations 312-322 can be updated using the same data to reflect the removal of filter 306.

On the other hand, the addition of one or more filters to another dimension, such as the “SFDC ACCOUNT ID” dimension, may require the querying of fully aggregated data from the server. For example, the “SFDC ACCOUNT ID” dimension may have 30,620 unique values, which exceeds the query result limit of 10,000 for the data set. Inclusion of a new filter on the “SFDC ACCOUNT ID” dimension with filters 302-310 may thus increase the cardinality associated with the filters to 864*30,620, or 26,455,680. Because the new cardinality is significantly more than the query result limit of 10,000, a query for the data associated with the filters may include metrics associated with visualizations 312-322 grouped by the dimensions associated with the filters, with the specific values associated with the new filter (e.g., four values for “SFDC ACCOUNT ID”) specified in the query. The cardinality associated with the query may be 864*4, or 3,456, which is lower than the query result limit.

Moreover, the subsequent addition of values to the filter may require additional querying of the data set. For example, the inclusion of an additional value for the “SFDC ACCOUNT ID” dimension in the filter may result in the generation of a query that contains the new value and the retrieval of data matching the query from the server.

Finally, non-aggregated data may be queried and used to generate visualizations 312-322. For example, a query for non-aggregated data may be used to retrieve data from the server and generate visualizations 312-322 if the total number of records matching the query is less than the query result limit and/or the user interface is associated with sufficient processing and/or memory resources to retrieve and process the entire data set in an efficient manner.

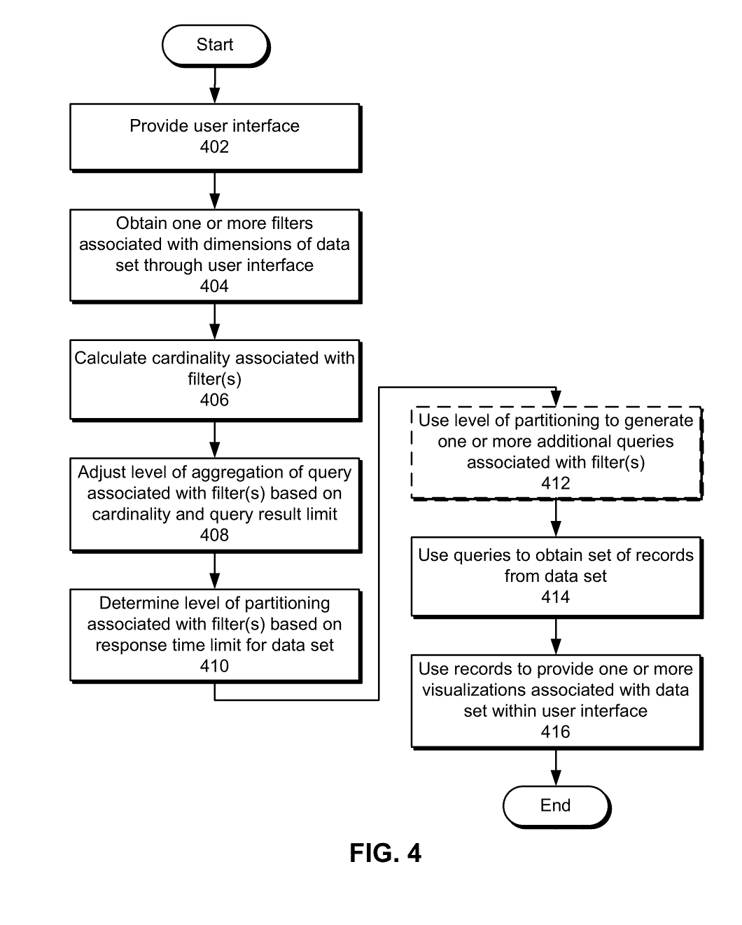

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a user interface is provided (operation 402), and one or more filters associated with dimensions of a data set are obtained through the user interface (operation 404). For example, the filters may be obtained using user-interface elements of a GUI provided by a web application. The filters may include values, ranges of values, and/or flags related to the dimensions.

Next, a cardinality associated with the filter(s) is calculated (operation 406). The cardinality may be calculated by obtaining a number of distinct values for each dimension associated with the one or more filters and multiplying the number of distinct values with numbers of distinct values for other dimensions associated with the one or more filters. For example, filters for four dimensions with two, three, four, and five distinct values may produce a cardinality of 2*3*4*5, or 120.

A level of aggregation of a query associated with the filter(s) is adjusted based on the cardinality and a query result limit (operation 408) for querying of the data set. The query result limit may represent a threshold associated with overloading of an application and/or data-processing system providing the user interface, such as a maximum number of records that can be processed by the application and/or data-processing system. The level of aggregation may be, for example, fully aggregated (e.g., to keep the number of records returned in response to the query from exceeding the query result limit), semi-aggregated (e.g., to retrieve more records than required by the filter(s)), and non-aggregated (e.g., to retrieve non-aggregated records in the data set).

A level of partitioning associated with the filter(s) is also determined based on a response time limit for the data set (operation 410), and the level of partitioning is optionally used to generate one or more additional queries associated with the filter(s) (operation 412). The response time limit may represent a threshold associated with overloading of a server processing the query, such as a timeout for the server. The level of partitioning may be increased to increase the number of queries sent to the server and reduce the amount of server processing required for each query, while the level of partitioning may be decreased to decrease the number of queries sent to the server and increase the amount of server processing required for each query, up to the response time limit.

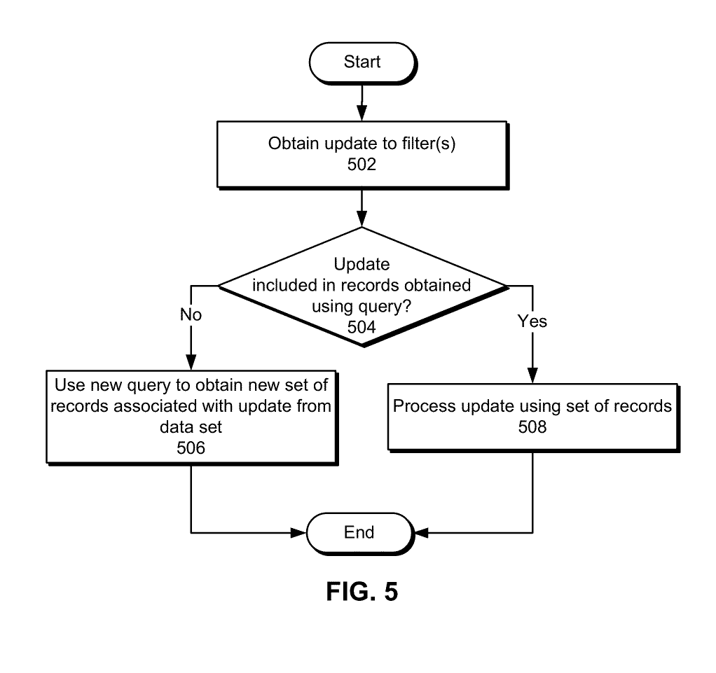

The queries are then used to obtain a set of records from the data set (operation 414), and the records are used to provide one or more visualizations associated with the data set within the user interface (operation 416). For example, the queries may be sent to the server over a network connection, and the records may be received in response to the queries from the server. The records may then be used to generate one or more charts and/or other graphical representations of the records in the user interface. Changes or updates to the filter(s) may further be processed using the records and/or additional querying of the data set, as described in further detail below with respect to FIG. 5.

FIG. 5 shows a flowchart illustrating the process of processing an update to one or more filters associated with dimensions of a data set in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, the update to the filter(s) is obtained (operation 502). The update may be obtained after the filter(s) are used to retrieve a set of records from a data set, as described above with respect to FIG. 4. For example, the filter(s) and the update may be obtained through a user interface that allows a user to specify the filter(s). To provide the update, the user may modify or remove an existing filter and/or add a new filter using user-interface elements of the user interface.

The update may be processed based on the inclusion of the update in a set of records obtained using a query (operation 504). For example, the set of records may previously be retrieved using a query for semi-aggregated data that is grouped by one or more dimensions associated with the filter(s). The update may thus be included in the records if the update changes the value of an existing filter, while the update may not be included in the records if the update adds a new filter.

If the update is not included in the records, a new query is used to obtain a new set of records associated with the update from the data set (operation 506). For example, a dimension and/or value of the dimension from the update may be included in the new query to retrieve data that matches the value and/or is grouped by the dimension. If the update is included in the records, the update is processed using the set of records (operation 508). For example, a new value of an existing filter may be used to select a subset of the records for inclusion in one or more visualizations associated with the data set without additional querying of the data set.

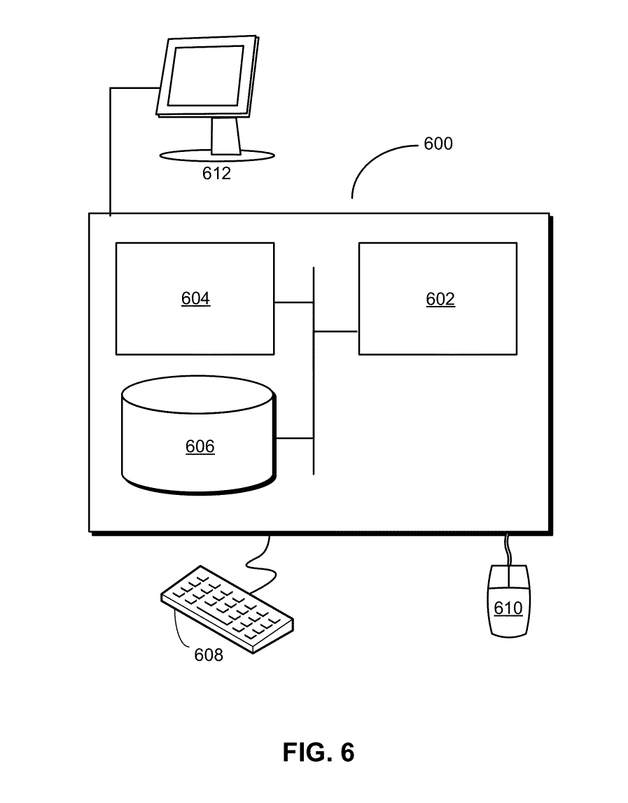

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include a query-generation apparatus that obtains one or more filters associated with dimensions of a data set and calculates a cardinality associated with the one or more filters. The query-generation apparatus may also adjust a level of aggregation of a query associated with the one or more filters based on the cardinality and a query result limit for the data set. The system may also include a communication apparatus that uses the query to obtain a set of records from the data set. Finally, the system may include a presentation apparatus that provides a user interface for obtaining the one or more filters and uses the set of records to provide one or more visualizations associated with the data set within the user interface.

In addition, one or more components of computer system 600 may be remotely located and connected to the other components over a network. Portions of the present embodiments (e.g., query-generation apparatus, communication apparatus, presentation apparatus, etc.) may also be located on different nodes of a distributed system that implements the embodiments. For example, the present embodiments may be implemented using a cloud computing system that performs querying of data sets from a remote server and provides visualizations associated with the data sets in a user interface.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing data, comprising:
obtaining one or more filters associated with dimensions of a data set;
calculating a cardinality associated with the one or more filters;
adjusting a level of aggregation of a query associated with the one or more filters based on the cardinality and a query result limit for querying of the data set; and
using the query to obtain a set of records from the data set.

2. The computer-implemented method of claim 1, further comprising:
obtaining an update to the one or more filters; and
upon determining that the update is not included in the set of records obtained using the query, using a new query to obtain a new set of records associated with the update from the data set.

3. The computer-implemented method of claim 2, further comprising:
upon determining that the update is included in the set of records obtained using the query, processing the update using the set of records.

4. The computer-implemented method of claim 1, further comprising:
determining a level of partitioning associated with the one or more filters based on a response time limit for querying of the data set;
using the level of partitioning to generate one or more additional queries associated with the one or more filters; and
using the one or more additional queries to obtain the set of records from the data set.

5. The computer-implemented method of claim 1, further comprising:
providing a user interface for obtaining the one or more filters; and
using the set of records to provide one or more visualizations associated with the data set within the user interface.

6. The computer-implemented method of claim 6, wherein the one or more visualizations are provided in a web browser.

7. The computer-implemented method of claim 1, wherein calculating the cardinality associated with the one or more filters comprises:
obtaining a number of distinct values for each dimension associated with the one or more filters; and
multiplying the number of distinct values with numbers of distinct values for other dimensions associated with the one or more filters.

8. The computer-implemented method of claim 1, wherein the query comprises one or more dimensions associated with the one or more filters and one or more metrics associated with the one or more dimensions.

9. The computer-implemented method of claim 1, wherein the one or more filters comprise at least one of a range, a value, and a flag.

10. The computer-implemented method of claim 1, wherein the level of aggregation is at least one of non-aggregated, semi-aggregated, and fully aggregated.

11. The computer-implemented method of claim 1, wherein the set of records comprises aggregated data that is associated with at least one of a sum, a count, a maximum, a minimum, and a summary statistic.

12. An apparatus, comprising:
one or more processors; and
memory storing instructions that, when executed by the one or more processors, cause the apparatus to:
obtain one or more filters associated with dimensions of a data set;
calculate a cardinality associated with the one or more filters;
adjust a level of aggregation of a query associated with the one or more filters based on the cardinality and a query result limit for querying of the data set; and
use the query to obtain a set of records from the data set.

13. The apparatus of claim 12, wherein the memory further stores instructions that, when executed by the one or more processors, cause the apparatus to:
obtain an update to the one or more filters;
upon determining that the update is not included in the set of records obtained using the query, use a new query to obtain a new set of records associated with the update from the data set; and
upon determining that the update is included in the set of records obtained using the query, process the update using the set of records.

14. The apparatus of claim 12, wherein the memory further stores instructions that, when executed by the one or more processors, cause the apparatus to:
determine a level of partitioning associated with the one or more filters based on a response time limit for querying of the data set;
use the level of partitioning to generate one or more additional queries associated with the one or more filters; and
use the one or more additional queries to obtain the set of records from the data set.

15. The apparatus of claim 12, wherein the memory further stores instructions that, when executed by the one or more processors, cause the apparatus to:
provide a user interface for obtaining the one or more filters; and
use the set of records to provide one or more visualizations associated with the data set within the user interface.

16. The apparatus of claim 12, wherein calculating the cardinality associated with the one or more filters comprises:
obtaining a number of distinct values for each dimension associated with the one or more filters; and
multiplying the number of distinct values with numbers of distinct values for other dimensions associated with the one or more filters.

17. The apparatus of claim 12, wherein the query comprises one or more dimensions associated with the one or more filters and one or more metrics associated with the one or more dimensions.

18. The apparatus of claim 12, wherein the level of aggregation is at least one of non-aggregated, semi-aggregated, and fully aggregated.

19. A system for processing data, comprising:
one or more processors;
a query-generation non-transitory computer readable medium comprising instructions that, when executed by the one or more processors, cause the system to configured to:
obtain one or more filters associated with dimensions of a data set;
calculate a cardinality associated with the one or more filters; and
adjust a level of aggregation of a query associated with the one or more filters based on the cardinality and a query result limit for querying of the data set; and
a communication non-transitory computer readable medium comprising instructions that, when executed by the one or more processors, cause the system to configured to use the query to obtain a set of records from the data set.

20. The system of claim 19, further comprising:
a presentation non-transitory computer readable medium comprising instructions that, when executed by the one or more processors, cause the system to configured to:
provide a user interface for obtaining the one or more filters; and
using the set of records to provide one or more visualizations associated with the data set within the user interface.
